(19) United States
(12) Patent Application Publication
(10) Pub. No.: US 2023/0211628 A1
(43) Pub. Date: Jul. 6, 2023

(54) ANIMATED SCISSOR HOLDER

(71) Applicant: Ali BOUDA, Encino, CA (US)

(72) Inventor: Ali BOUDA, Encino, CA (US)

(21) Appl. No.: 18/093,752

(22) Filed: Jan. 5, 2023

Related U.S. Application Data
(60) Provisional application No. 63/296,510, filed on Jan. 5, 2022.

(51) Int. Cl. B43M 99/00; B26B 29/04

(52) U.S. Cl. CPC B43M 99/001; B26B 29/04

(57) ABSTRACT

An animated scissor holder having a housing with an opening and a guide to linearly receive and guide blades tips of a pair of scissors. A stop is adapted to impeded linear movement of the blade tips sliding through the guide at a predetermined distance. An object is movably connected to the housing and a gear assembly adapted to move the object in response to the linear movement of the blade tips. The gear assembly has a drive gear adapted to transfer the linear movement into rotational movement about a first axis. A set of driven teeth are attached to the object. The drive gear translates motion to the driven teeth to move the object from a first position to a second position.

### CROSS REFERENCE TO RELATED APPLICATION

This application incorporates and claims priority of U.S. Provisional Application Ser. No. 63/296,510, filed Jan. 5, 2022, the entirety of which is incorporated herein by reference.

### TECHNICAL FIELD

The subject disclosure relates generally to a decorative scissor holder, and in particular when a pair of scissors are inserted into the decorative scissor holder, a portion of the scissor holder is animated by causing a movable portion of the holder to be moved.

### BACKGROUND

Conventional scissors have been developed with a construction to allow scissors to stand upright on a desk. Likewise, stands are known to hold a pair of scissors in an upright position to minimize the footprint taken away from the surface area on a desk. However, a scissor holder capable of efficiently storing as well as providing animation is not known.

### SUMMARY

An object of this subject disclosure, is to provide an animated scissor holder is provided that has a housing with an opening and a guide to linearly receive and guide blades tips of a pair of scissors. A stop is adapted to impeded linear movement of the blade tips sliding through the guide at a predetermined distance. An object is movably connected to the housing and a gear assembly is adapted to move the object in response to the linear movement of the blade tips. The gear assembly has a drive gear adapted to transfer the linear movement into rotational movement about a first axis. A set of driven teeth are attached to the object. The drive gear translates motion to the driven teeth to move the object from a first position to a second position.

### BRIEF DESCRIPTION OF THE DRAWINGS

Various exemplary embodiments of this disclosure will be described in detail, wherein like reference numerals refer to identical or similar components or steps, with reference to the following figures, wherein:

FIG. 1 is a perspective view of a scissor holder in an animated first position without scissors inserted into the holder and the head of the animal in a first position according to this subject disclosure.

FIG. 2 is a perspective view of a scissor holder in an animated intermediate position with scissors partially inserted into the holder and the head of the animal in the intermediate position.

FIG. 3 is a perspective view of a scissor holder in an animated second position with scissors completely inserted into the holder and the head of the animal in a second position.

FIG. 4 shows a rear view of the scissor holder with a portion of the housing removed and the head of the animal in the animated first position with blade tips of the scissors beginning to engage an arm of a drive gear.

FIG. 5 shows a rear view of the scissor holder with a portion of the housing removed and the head of the animal partially rotated into an animated intermediate position with blade tips of the scissors substantially engaged with and moving the arm of a drive gear.

FIG. 6 shows a rear view of the scissor holder with a portion of the housing removed and the head of the animal in an animated second position completely inserted into the holder with blade tips of the scissors engaged with the arm of the drive gear and the head of the animal fully rotated at approximately 90 degrees.

FIG. 7 shows a lower perspective view of a rear view of the scissor holder with a portion of the housing removed, with the scissors beginning to engage the arm of the drive gear, and the head of the animal in the first position.

FIG. 8 shows a lower perspective view of a rear view of the scissor holder with a portion of the housing removed, with the scissors substantially inserted into the holder at an intermediate position with the head of the animal partially rotated into an intermediate position.

FIG. 9 shows a lower perspective view of a rear view of the scissor holder with a portion of the housing removed, and with the scissors fully inserted into the holder and fully extended and engaged with the arm of the drive gear at a rest position with the head of the animal completely rotated into the second position.

FIG. 10 shows a front partial x-ray view of the scissor holder in the second position with the scissors completely inserted into the holder and the head of the animal completely turned approximately 90 degrees.

FIG. 11 shows a rear view of the scissor holder with a portion of the housing removed, and the head of the animal in the first position with scissors beginning to engage the arm of the drive gear within the holder.

FIG. 12 shows a rear view of the scissor holder with a portion of the housing removed, and the head of the animal more defined and in the first position with scissors beginning to engage the arm of the drive gear within the holder.

FIG. 13 is an exploded lower perspective view of the scissor holder with a portion of the housing removed, and with a pair of scissors inserted into a sheath that engages a drive gear that is adapted to rotate a portion of the head of the animal.

FIG. 14 is an enlarged front view of an internal mechanical connection that moves the animals head from a first position through the intermediate position to the second position when the scissors are inserted into a sheath.

### DETAILED DESCRIPTION

Particular embodiments of an animated scissor holder will now be described in greater detail with reference to the figures.

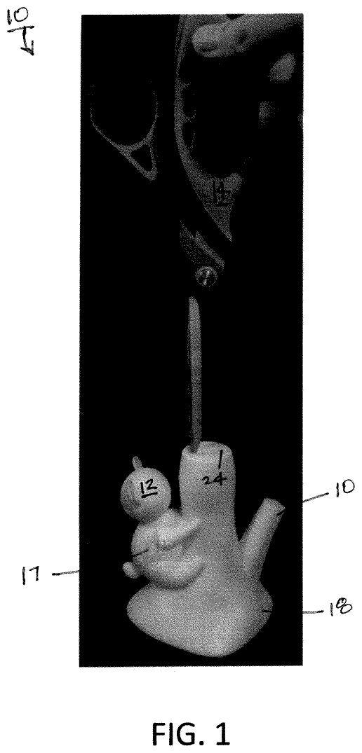

FIG. 1 is a perspective view of a scissor holder 10 in a first position where a pair of scissors 14 are about to be inserted into an opening 24 in the holder 10 according to this subject disclosure. In this first position, a head 12 of the koala 17 is facing the opening 24.

For exemplary purposes, the scissor holder 10 resembles a koala 17 holding onto a tree 18. Although shaped as a koala 17 and a tree 18, it is to be understood that the scissor holder 10 can take a variety of different shapes. The housing 20 of the scissor holder is static, and the head 12 of the koala 17 is movable. For example, the scissor holder 10 may take the shape of other animals, vehicles, like a car, train, airplane, fire engine, raft, cruise ship, ferry boat, spaceship, rocket, stick of dynamite, cartoon bomb, a piece of fruit, a tree, a leaf, a globe and the like according to this subject disclosure.

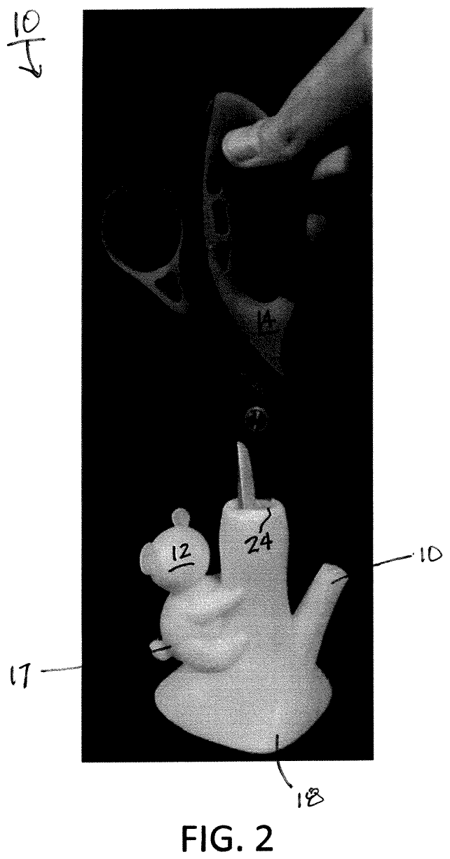

FIG. 2 is a perspective view of the scissor holder 10 in an intermediate position with scissors 14 partially inserted into the opening 24 in the holder 10. In this intermediate position, the blade tip 16 of the scissors 14 have been inserted further into the opening 24 and the head 12 of the koala 17 has been partially turned from the first position in which the head 12 was facing the opening 24 of the housing 20.

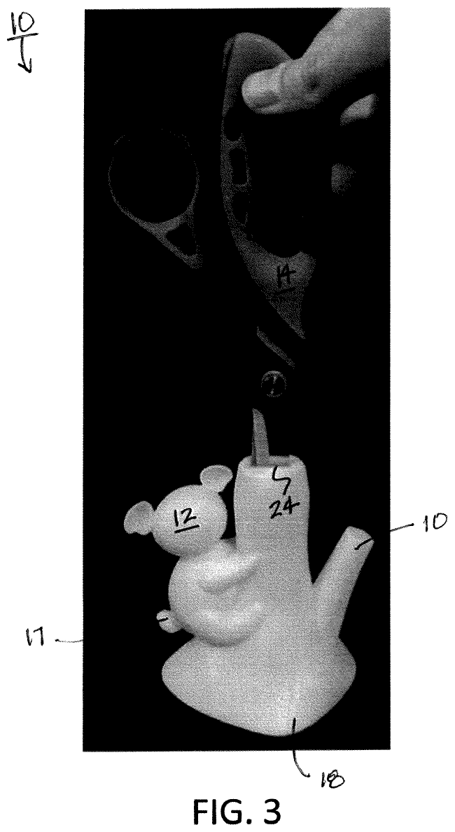

FIG. 3 is a perspective view of the scissor holder 10 at a completely rotated second position with the scissors 14 fully inserted into the opening 24, and at rest within the scissor holder 10. In this second position, the head 12 of the koala 17 has turned approximately 90 degrees from the first position in which the head 12 was facing the opening 24 of the housing 20, into this final second position in which the head 12 of the koala 17 is turned sideways, facing forward.

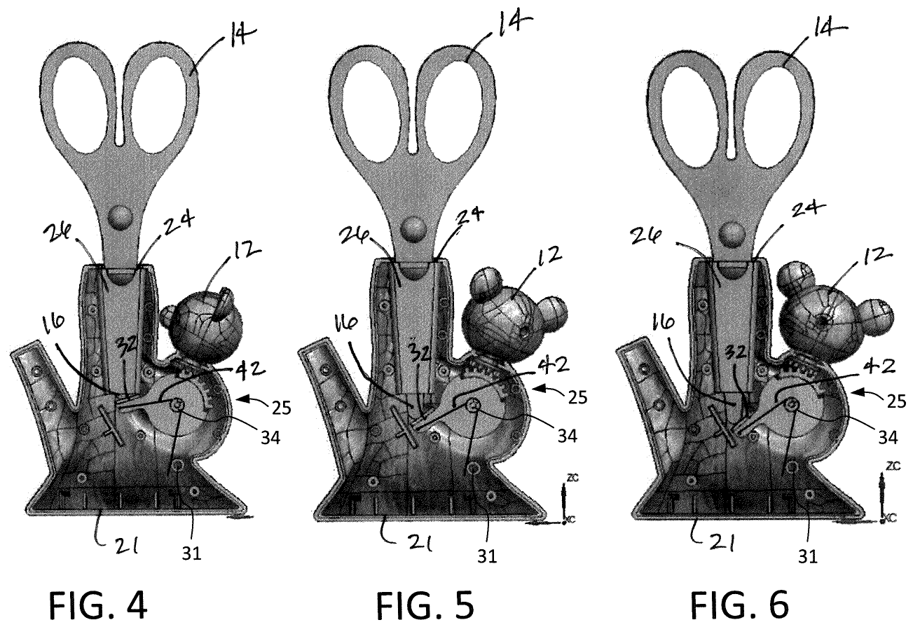

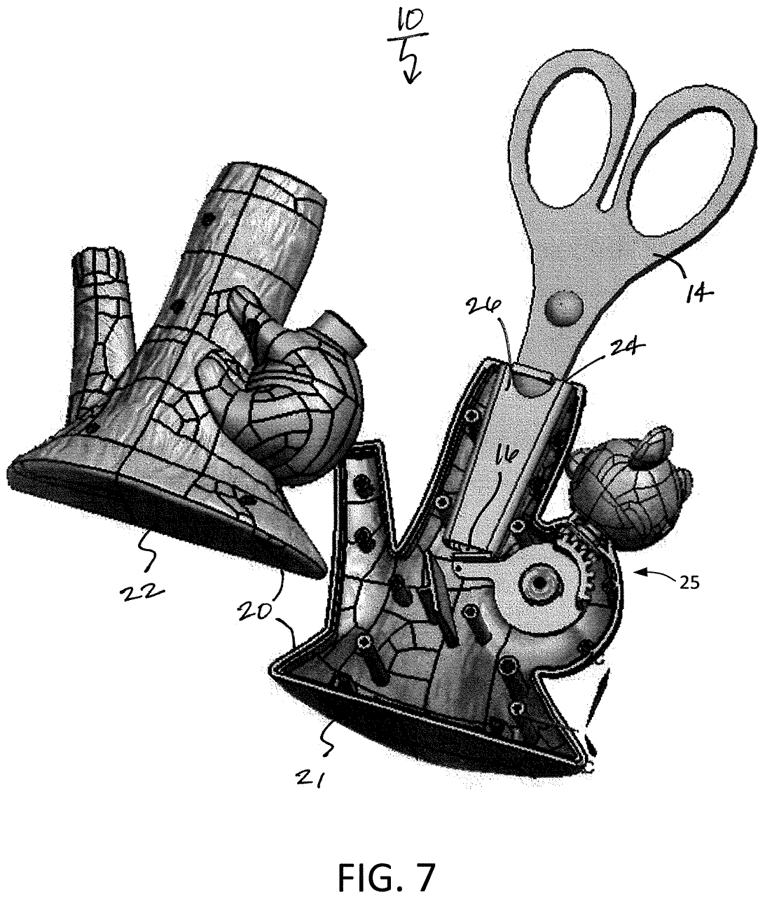

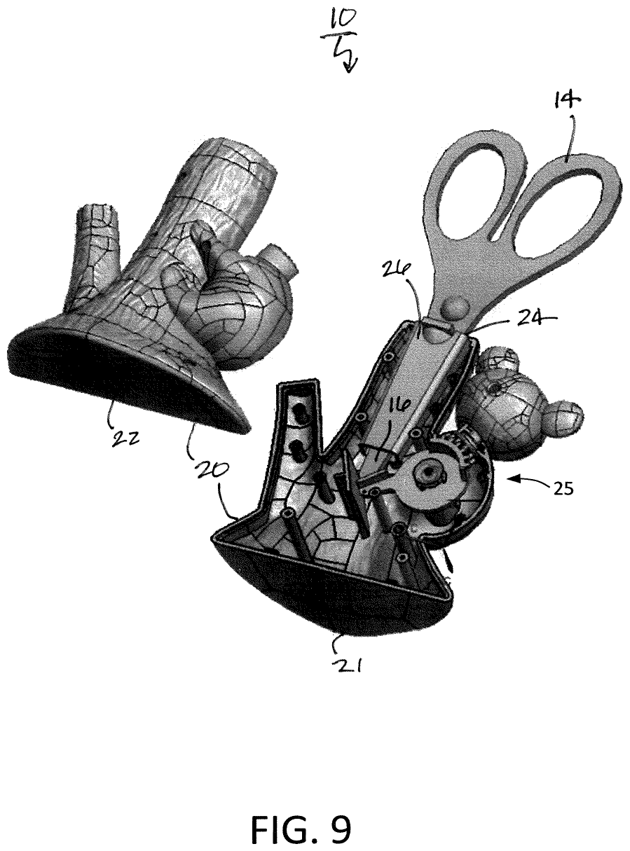

FIGS. 4, 5 and 6 correspond to FIGS. 7, 8 and 9 respectively, and show rear views of the of the scissor holder 10 with a rear portion 22 of the housing 20 removed from the front portion 21. FIGS. 7, 8 and 9 show lower perspective views of rear views of the scissor holder 10 with a rear portion 22 of the housing 20 removed from the front portion 21. An animation gear assembly 25 is provided within the housing 20 to convert the linear motion of the insertion movement of the blade tips 16 into the sheath 26, into coordinated rotational motion through a drive gear 30 and a driven gear 50 to move the head 12 of the koala 17 from the first position (shown in FIG. 1), through the intermediate position (FIG. 2) and into to the second position (shown in FIG. 3) as will be described in more detail below.

In particular, FIGS. 4 and 7 show the blade tip 16 of the scissors 14 inserted into a guide or a sheath 26 and just beginning to engage an arm 32 of a drive gear 30. In this first position, the head 12 of the koala 17 is facing the opening 24 in the sheath 26.

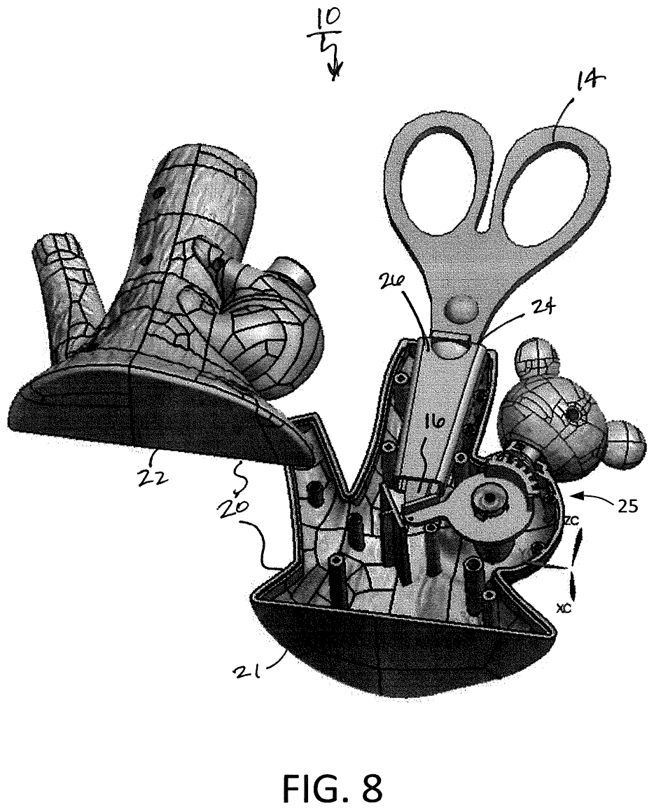

FIGS. 5 and 8 shows the blade tip 16 of the scissors 14 inserted further into the sheath 26 at an intermediate position. In this intermediate position, the blade tips 16 of the scissors 14 have pressed against the arm 32 and caused it to rotate in a counterclockwise direction about a central pivot 34. The head 12 of the koala 17 is partially turned away from the first position in which the head 12 of the koala 17 was facing the opening 24 in the sheath 26.

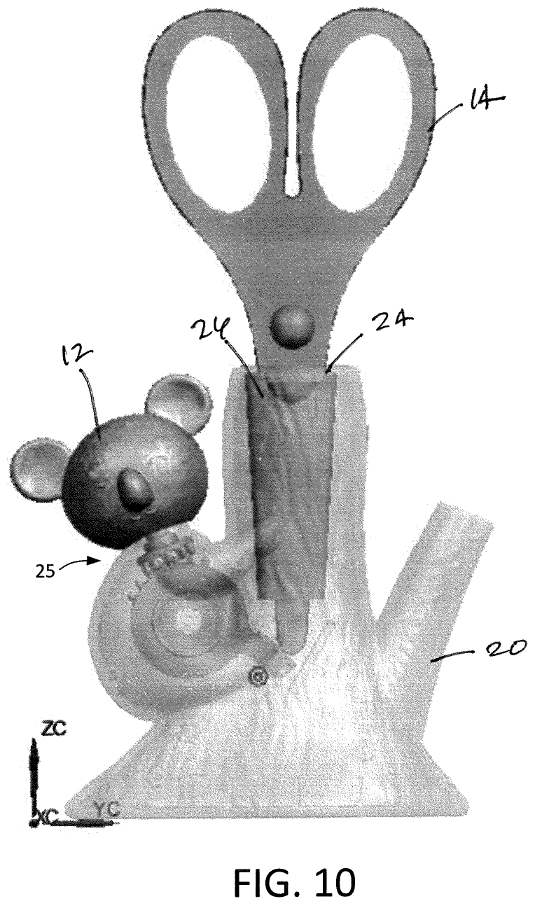

FIGS. 6, 9 and 10 shows the blade tip 16 of the scissors 14 is fully inserted into the sheath 26. In this second position, the scissor 14 is in a storage position. That is, the blade tips 16 of the scissors 14 have pressed in as far as they can go within the sheath 26. The blade tips 16 press against the arm 32 causing it to rotate as far as it could in the counterclockwise direction about a central pivot 34 until the arm 32 engages the arm stop 38. In this second position shown in x-ray in FIG. 10, in which the face of the koala 17 is forward facing, the head 12 of the koala 17 is completely rotated and turned away from the first position at approximately 90 degrees from the first position which faced the opening 24 in the sheath 26.

As shown in FIGS. 4-5, a spring 42 is provided on the drive gear 30 and connected to the arm 32 and a projection 31 on the housing 20. Within the animated gear assembly 25, the spring 42 is positioned to provide a spring bias force to the arm 32 of the drive gear 30 so that when the weight of the scissors 14 pressing at the blade tips 16 onto the upper surface 33 of the arm 32 has been removed from the housing 20, the animated gear assembly 25 will return to its first position. That is, the driven gear 50 and the arm 32 on the drive gear 30 will rotate clockwise back from the second position into its first position, thereby returning the head 12 of the koala 17 back to its original direction in the first position.

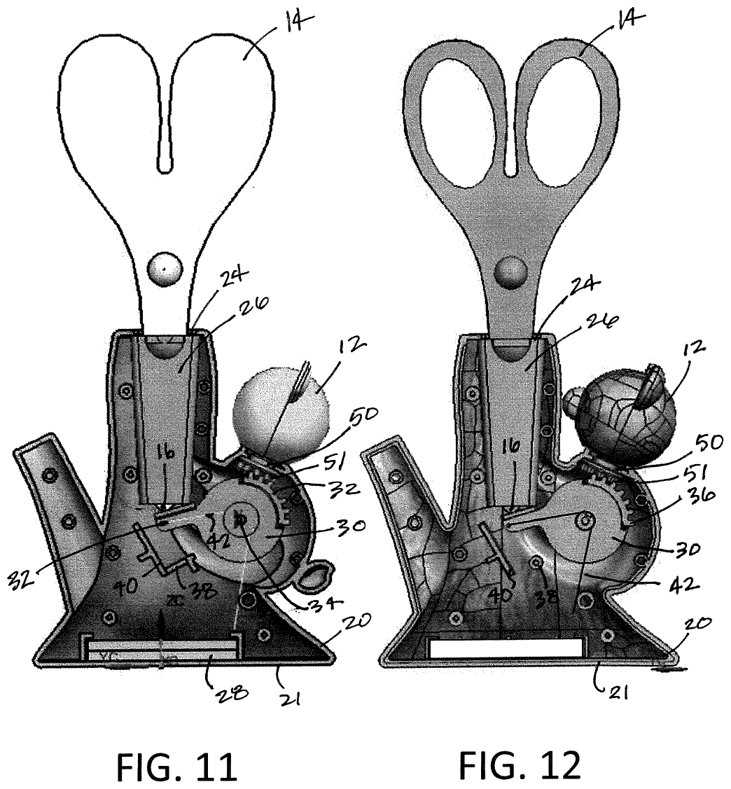

FIGS. 11 and 12 illustrate front internal views of the scissor holder 10 within the front portion 21 of the housing 20. The head 12 of the koala 17 is in the first position facing the opening 24. The rear portion 22 of the housing 20 has been removed so that the internal structure of the scissor sholder 10 can be better viewed. FIGS. 11 and 12 shows the internal view of the scissor holder 10 in the first position with the head 12 of the koala 17 facing the opening 24 and with the scissors 14 disposed within the sheath 26.

As shown, the blade tip 16 of the scissors 14 has been inserted into the opening 24 of the sheath 26 sufficiently far enough to engage the arm 32. The arm 32 is configured as a circular drive gear 30 that rotates around the central pivot 34. Drive teeth 36 are disposed on peripheral surface of the drive gear 30. When the blade tip 16 comes into contact with an upper surface 33 of the arm 32 on the drive gear 30, the drive gear 30 rotates about the central pivot 34 in a clockwise direction and mates with a driven gear 50. The driven gear 50 is integrated onto a lower end of the head 12 of the koala 17. The driven gear 50 is radially positioned in a plane that is perpendicular to a rotating plane that the drive gear 30 turns within.

Referring back to FIGS. 11 and 12, within the animated gear assembly 25, the housing 20 has a pair of stops 40, 38 that are located at a predetermined position to prevent the blade tips 16 of the scissors 14 from travelling too far within the housing 12. Likewise, the length of travel of the blade tips 16 within the housing 20 corresponds to the rotational movement necessary to rotate the koala's head 12 from a first desired position (shown in FIGS. 1, 4 and 7), through the intermediate position (shown in FIGS. 2, 5 and 8), and into a final desired second position (shown in FIGS. 3, 6 and 9).

According to this subject disclosure, in the second position, the head 12 of the koala 17 is approximately 90 degrees from the first position. It is to be understood that the animated animal or object may be rotated at any preferred degree according to this subject disclosure.

As shown, the arm stop 38 is provided below the arm 32 a substantial distance and acts as a barrier stop when the arm 32 is rotated a predetermined rotational distance corresponding with turning the head 12 of the koala at approximately 90 degrees. A blade stop 40 is also provided within the housing. A combination of the positioning of the blade stop 20 and the arm stop 38 prevent the blade tips 16 from advancing further within the housing 20 at a predetermined distance within the housing 20 when a lower surface 35 of the arm 32 backs up against the arm stop 38. That is, the blade stop 40 and the arm sop 38 permits the blade tips 16 to be positioned within the housing 20 at an optimal depth to securely hold the blade tips 16 in place within the sheath 26. It is also to be understood that the pair of stops 40, 38 may be constructed in a variety of different ways as shown. It is also possible to configure the stops 40, 38 as a single integrated stop which can serve the same purpose.

In particular, in the animated gear assembly 25, the drive gear 30 is circular and has the arm 32 extending from one side of the drive gear 30 that engages the ends of the blade tips 16. An opposite side of the drive gear 30 has a plurality of drive gear teeth 36 on its periphery. The linear motion of the blade tip 16 of the scissors 14 being placed into the sheath 26 is converted into a rotational motion through the drive gear 30 around the central pivot 34. The drive gear teeth 36 engage the driven gear teeth 51 on the driven gear 50.

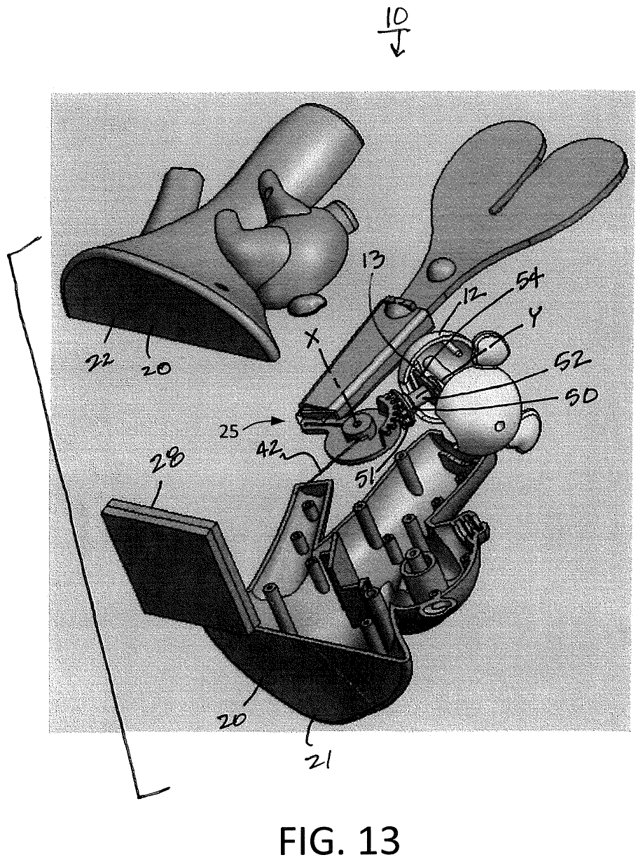

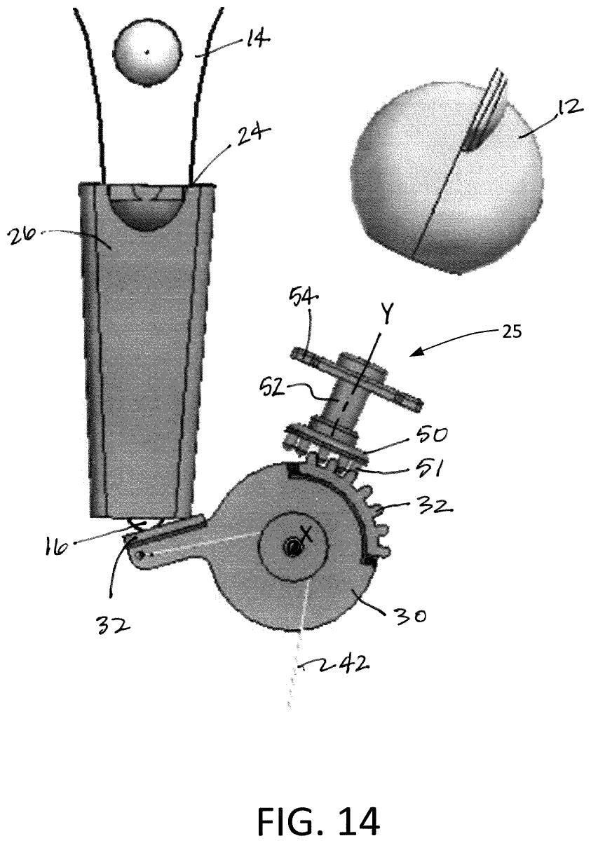

As shown in FIGS. 11, 12 and 13-14, the driven gear 50 rotates in a second plane perpendicular to a first plane in which the drive gear 30 rotates within. As shown in FIG. 13, the drive gear 30 rotates about a first axis X that is perpendicular to a second axis Y that the driven gear 50 rotates around. This rotational connection transfers the impact engagement of the blade tips 16 against the arm 32 to be transferred through the drive gear 30 around the first axis X into the driven gear 50 which rotates around the second axis Y. This translation of movement causes the head 12 of the animal to rotate from the first position, through the intermediate position and coming to a resting at the second position.

FIGS. 11-14 show the driven gear 50 having a set of driven gear teeth 51 attached to an axle 52 at a first end, and a key 54 attached to a second end of the axle 52. As best shown in FIG. 13, the key 54 is positioned and fixed within a receiving slot 13 constructed within the head 12. When the driven gear 51 is rotated (on the Y axis) by the drive gear 30 (rotating on the X axis), the axle 52 and the key 54 are moved from the first position through the intermediate position to the third position along the second rotational axis Y, which in turn turns the head 12 of the koala 17 when the blade tip 16 of the scissors 14 is completely inserted into the sheath 26.

FIGS. 11 and 13 more clearly illustrate various weights 28 that can be positioned within the housing 20. The weights 28 disposed in the housing 20 will secure the housing 20 in an upright position when the weight of the scissors 14 are inserted in the sheath 26. The weights 28 disposed at the lower end will prevent the upper end of the holder 10 from becoming too top heavy when the scissors 14 are inserted into the sheath 26.

The illustrations and examples provided herein are for explanatory purposes and are not intended to limit the scope of the appended claims. It will be recognized by those skilled in the art that changes or modifications may be made to the above described embodiment without departing from the broad inventive concepts of the invention. It is understood therefore that the invention is not limited to the particular embodiments described herein, but is intended to cover all modifications and changes within the scope and spirit of the invention.

What is claimed:

1. An animated scissor holder comprising:
a housing having an opening and a guide to linearly receive and guide blades tips of a pair of scissors;
a stop adapted to impeded linear movement of the blade tips sliding through the guide to a predetermined distance;
an object movably connected to the housing; and
a gear assembly adapted to move the object in response to the linear movement of the blade tips, the gear assembly comprising:
a drive gear adapted to transfer the linear movement into rotational movement about a first axis; and
a set of driven teeth attached to the object, wherein the drive gear translates motion to the driven teeth to move the object from a first position to a second position.

2. The animated scissor holder recited in claim 1, wherein the drive gear has an arm and a set of drive teeth.

3. The animated scissor holder recited in claim 2, wherein the drive gear is circular and rotates around a central pivot, and wherein the blade tips engage, and push against, the arm of drive gear to rotate the drive teeth against the driven teeth to move the object from the first position to the second position.

4. The animated scissor holder recited in claim 1, wherein the set of driven teeth are provided on a driven gear that engages with the drive gear to rotate the driven gear about a second axis.

5. The animated scissor holder recited in claim 4, wherein the first axis and the second axis are approximately 90 degrees from each other.

6. The animated scissor holder recited in claim 1, further comprising weights disposed in a base of the housing to provide stability to counteract the weight of the scissors disposed within the animated scissor holder.

7. The animated scissor holder recited in claim 1, wherein the housing is fixed and resembles a tree and body of a koala, and the object is movable and resembles a head of the koala.

8. The animated scissor holder recited in claim 1, wherein the guide is a sheath adapted to receive and guide the blade tips to an arm on the drive gear.

9. The animated scissor holder recited in claim 1, wherein the stop is one or more stops adapted to impeded linear movement of the blade tips sliding through the guide to a predetermined distance.

10. The animated scissor holder recited in claim 1, wherein the driven teeth are attached to the object through an axle having a key located in a key receiving slot disposed within the object.

11. An animated scissor holder comprising:
a housing having an opening to linearly receive and guide blades tips of a pair of scissors;
a stop adapted to impeded linear movement of the blade tips sliding through the guide to a predetermined distance;
a moveable object; and
an animation gear assembly adapted to animate the moveable object, the animation gear assembly comprising:
a drive gear having an arm and a set of drive teeth, the drive gear adapted to transfer linear movement, received from the blade tips on the arm, into rotational movement of the drive gear on a first axis; and
a driven gear having a set of driven teeth attached to the movable object, the driven teeth are adapted to engage with the drive teeth to rotate the driven gear about a second axis relative to the first axis, wherein the movable object is rotated from a first position to a second position.

12. The animated scissor holder recited in claim 11, further comprising a sheath disposed within the housing that linearly receives and guides the blades tips of the scissors.

13. The animated scissor holder recited in claim 11, wherein the stop is one or more stops adapted to impeded linear movement of the blade tips sliding through the guide to a predetermined distance.

14. The animated scissor holder recited in claim 11, further comprising weights disposed in a base of the housing to provide stability to counteract the weight of the scissors disposed within the scissor holder.

15. The animated scissor holder recited in claim 11, wherein the housing is fixed and resembles a tree and body of a koala, and the movable object rotates and resembles a head of the koala.

16. The animated scissor holder recited in claim 11, wherein the driven teeth are attached to the movable object through an axle having a key located in a key receiving slot disposed within the object.

17. An animated scissor holder comprising:
a housing having an opening to linearly receive blades tips of a pair of scissors;
a sheath within the housing adapted to receive and guide the blade tips;
a stop adapted to impeded linear movement of the blade tips sliding through the sheath to a predetermined distance;
a head of an animal; and
a gear assembly adapted to animate the head of the animal, the gear assembly comprising:
a drive gear having an arm and a set of drive teeth, the arm adapted to convert linear movement by the blade tips to rotate the drive gear about a pivot on a first axis; and
a driven gear having a set of driven teeth attached to the head of the animal, the driven teeth are adapted to engage with the drive teeth of the drive gear to rotate the driven gear about a second axis that is substantially perpendicular to the first axis,
wherein when the driven gear is rotated, the head of the animal is rotated from a first position to a second position approximately 90 degrees from the first position.

18. The animated scissor holder recited in claim 17, wherein the driven teeth are attached to the head of the animal through an axle having a key located in a key receiving slot disposed within the head of the animal.

19. The animated scissor holder recited in claim 17, wherein the housing is fixed and resembles a tree and body of a koala, and the head of the animal rotates and resembles a head of the koala.

20. The animated scissor holder recited in claim 17, further comprising weights disposed in a base of the housing to provide stability to counteract the weight of the scissors disposed within the animated scissor holder.
